(19) United States
(12) Patent Application Publication
(10) Pub. No.: US 2018/0372440 A1
(43) Pub. Date: Dec. 27, 2018

(54) WEAPON BARREL ATTACHMENT FOR TRIGGERING INSTRUMENTATION LASER

(71) Applicant: Cubic Corporation, San Diego, CA (US)

(72) Inventors: Martyn Armstrong, Salisbury (GB); Neale Smiles, Salisbury (GB); Steven Taylor, Chilmark (GB); David Boissel, Salisbury (GB); Alastair Parkinson, Wilton (GB); Andrew Fox, Chippenham (GB)

(73) Assignee: Cubic Corporation, San Diego, CA (US)

(21) Appl. No.: 15/814,816

(22) Filed: Nov. 16, 2017

Related U.S. Application Data
(60) Provisional application No. 62/523,621, filed on Jun. 22, 2017.

(51) Int. Cl. F41A 33/02; F41G 11/00; F41G 3/26; F41J 5/02; H04W 4/80

(52) U.S. Cl. CPC F41A 33/02; F41G 11/003; F41A 33/06; F41J 5/02; H04W 4/80; F41G 3/2655

(57) ABSTRACT

A weapon system including a weapon attachment for attaching to a barrel of a weapon. The weapon attachment may include a light receiving device configured to receive a first light signal transmitted within the barrel. The weapon attachment may also include a first interface for communicating with a weapon-mountable instrumentation laser. The instrumentation laser may be attached to the weapon and may be configured to transmit a second light signal. The weapon attachment may further include a processing unit coupled with the light receiving device. The processing unit may be configured to receive, via the light receiving device, the first light signal, and to transmit an instruction signal to the instrumentation laser via the first interface causing the instrumentation laser to transmit the second light signal.

### CROSS-REFERENCES TO RELATED APPLICATIONS

This application is a nonprovisional of and claims the benefit of priority to U.S. Provisional Patent Application No. 62/523,621, filed Jun. 22, 2017, entitled “BLUE TOOTH FIRING ATTACHMENT,” the content of which is herein incorporated in its entirety.

### BACKGROUND OF THE INVENTION

The development of ammunition blanks, in which a cartridge is loaded with gunpowder without a bullet, has allowed users to simulate the basic live firing conditions of a weapon (e.g., gunshot sound, muzzle flash, recoil) without firing a projectile. However, infantry training using ammunition blanks is limited due to the inability to determine whether the user is aligning the weapon properly, and therefore has limited use in infantry training scenarios. Furthermore, when used with high firing rate weapons, such as machine guns or assault rifles, ammunition blanks may become overly expensive. As an alternative, laser communication devices attached to weapons have been employed. Although such devices are able to determine whether a weapon is properly aligned with a target, many of the live firing conditions are lost. Accordingly, new systems, methods, and other techniques are needed.

### BRIEF SUMMARY OF THE INVENTION

Embodiments described herein may include methods, systems, and other techniques for implementing a weapon system employing optical devices. In some embodiments, a weapon attachment for attaching to a barrel of a weapon is provided. The weapon attachment may include a light receiving device configured to receive a first light signal transmitted within the barrel. The weapon attachment may also include a first interface for communicating with a weapon-mountable instrumentation laser. In some embodiments, the instrumentation laser is attached to the weapon and is configured to transmit a second light signal. The weapon attachment may further include a processing unit coupled with the light receiving device. In some embodiments, the processing unit may be configured to perform operations including receiving, via the light receiving device, the first light signal, and in response to receiving the first light signal, transmitting an instruction signal to the instrumentation laser via the first interface. In some embodiments, the instruction signal may cause the instrumentation laser to transmit the second light signal.

In some embodiments, the weapon attachment may include a second interface for communicating with a communication device via wireless radio frequency (RF) signals. In some embodiments, the communication device may be configured to communicate with a central computing system via a wide area network (WAN). In some embodiments, the operations may also include in response to receiving the first light signal, transmitting an information signal to the communication device via the second interface. In some embodiments, the information signal may indicate that the first light signal was received by the weapon attachment. In some embodiments, the second interface may enable the processing unit to transmit the information signal to the communication device using a Bluetooth connection. In some embodiments, the first light signal may be transmitted by an internal laser. In some embodiments, the weapon attachment may include an orientation module configured to detect an indication of an orientation of the weapon and to send the indication of the orientation of the weapon to the processing unit. In some embodiments, the first interface may enable the processing unit to transmit the instruction signal to the instrumentation laser using an infrared wireless connection.

In some embodiments, a method is provided. The method may include receiving, by a processing unit via a light receiving device, a first light signal transmitted within a barrel of a weapon. In some embodiments, a weapon attachment for attaching to the barrel of the weapon includes the processing unit and the light receiving device. The method may also include in response to receiving the first light signal, transmitting, by the processing unit, an instruction signal to an instrumentation laser via a first interface. In some embodiments, the instruction signal may cause the instrumentation laser to transmit a second light signal. In some embodiments, the instrumentation laser is attached to the weapon. In some embodiments, the weapon attachment may include a second interface for communicating with a communication device. In some embodiments, the communication device may be configured to communicate with a central computing system via a WAN. The method may further include in response to receiving the first light signal, transmitting, by the processing unit, an information signal to the communication device via the second interface. In some embodiments, the information signal indicating that the first light signal was received by the weapon attachment.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example of a weapon system, according to some embodiments of the present disclosure.

FIG. 2 shows an example of various components within a weapon system, according to some embodiments of the present disclosure.

FIG. 3 shows an example of a block diagram of a weapon attachment, according to some embodiments of the present disclosure.

FIG. 4 shows an example of a weapon attachment attaching to the end of a barrel of a weapon, according to some embodiments of the present disclosure.

FIG. 5 shows an example of a weapon attachment attaching to the end of a barrel of a weapon, according to some embodiments of the present disclosure.

FIG. 6 shows an example of a weapon attachment attaching to the end of a barrel of a weapon, according to some embodiments of the present disclosure.

FIG. 7 shows an example of a weapon attachment attaching to the end of a barrel of a weapon, according to some embodiments of the present disclosure.

FIG. 8 shows an example of a flow diagram of a method, according to some embodiments of the present disclosure.

FIG. 9 shows an example of a simplified computer system, according to some embodiments of the present disclosure.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label irrespective of the suffix.

### DETAILED DESCRIPTION OF THE INVENTION

Various specific embodiments will be described below with reference to the accompanying drawings constituting a part of this specification. It should be understood that, although structural parts and components of various examples of the present disclosure are described by using terms expressing directions, e.g., “front”, “back”, “upper”, “lower”, “left”, “right” and the like in the present disclosure, these terms are merely used for the purpose of convenient description and are determined on the basis of exemplary directions displayed in the accompanying drawings. Since the embodiments disclosed by the present disclosure may be set according to different directions, these terms expressing directions are merely used for describing rather than limiting. Under possible conditions, identical or similar reference numbers used in the present disclosure indicate identical components.

The development of ammunition blanks has allowed users to simulate the basic live firing conditions of a weapon (e.g., gunshot sound, muzzle flash, recoil) without firing a projectile. However, ammunition blanks are expensive and do not provide a means for determining whether the weapon is aligned properly with a target. As an alternative, laser communication devices attached to weapons have been employed. Many of these devices are attached externally to a weapon so as to provide a simulated bullet trajectory that may be received by an optical receiver located on a target. Other devices may be situated internally within a weapon so as to simulate one or more live firing conditions, such as a low power optical signal that is transmitted within a barrel of a weapon to simulate a muzzle flash. Such internal devices are incapable of linking with external laser devices for various reasons including, but not limited to, lack of necessary volume inside the weapon for communication and power components, presence of electromagnetic shielding provided by the weapon material (e.g., metal), and strong vibrations within the weapon caused by a recoil generator.

Embodiments of the present disclosure represent a significant improvement over currently available laser communication devices. Specifically, embodiments of the present disclosure include a weapon system in which a weapon attachment providing live firing conditions is attached to the barrel of the weapon. The weapon system also includes a high-power instrumentation laser attached to the weapon, a low-power internal laser situated within the barrel, action, chamber, and/or cylinder of the weapon, and a mobile communication device configured to communicate with a central computing system via a wide area network (WAN). The weapon system is realistic, easy to use, and provides real-time information regarding the weapon which may be analyzed by the central computing system.

Used herein, the term “weapon” may refer to any device, either real or imitation, designed to discharge projectiles or other materials. Accordingly, the term “weapon” as used herein may include a ready-to-fire weapon, a decommissioned weapon, a disarmed weapon, an imitation weapon, a toy weapon, and the like. Used herein, the term “barrel” may refer to any part of the weapon, either real or imitation, designed to facilitate a projectile from exiting the weapon. The term “barrel” also includes any items attached to the barrel of the weapon, such as a flash hider, a compensator, a silencer, a muzzle brake, an extended barrel, and the like.

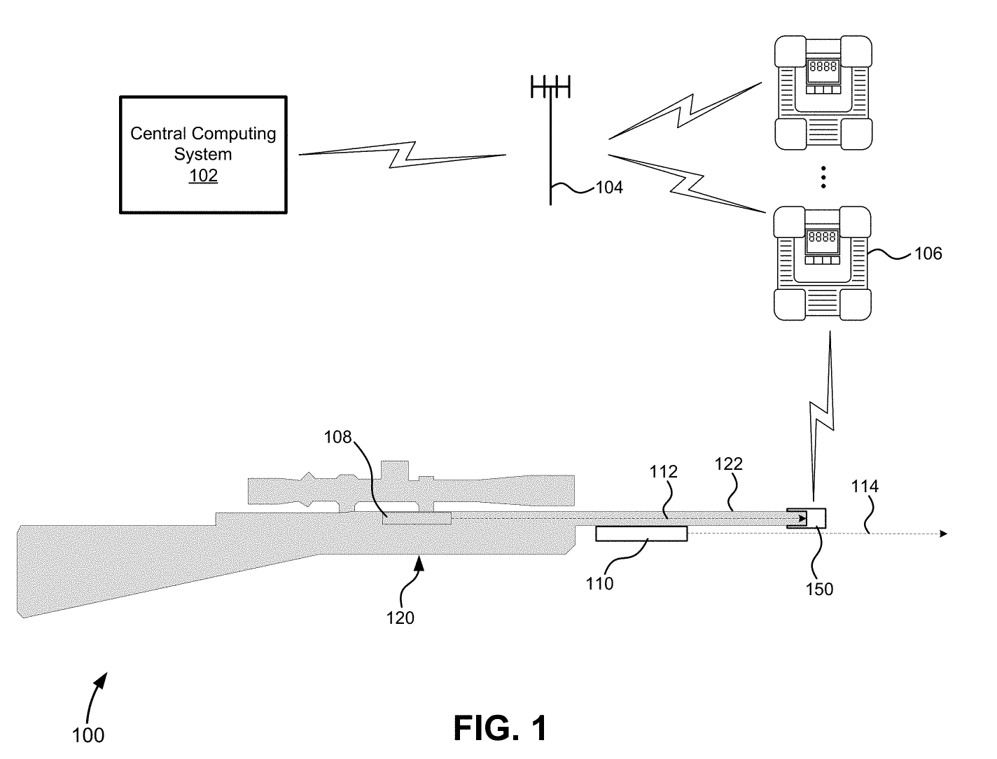

FIG. 1 shows an example of a weapon system 100, according to some embodiments of the present disclosure. In one implementation, weapon system 100 may be used to create a simulated environment for weapon training and/or combat training, i.e., weapon system 100 can allow soldiers to not only train how to use their weapons, but also tactical strategy training. Weapon system 100 may include a weapon 120, a weapon attachment 150 attached to weapon 120, an instrumentation laser 110 attached to weapon 120, a communication device 106 in data communication with weapon attachment 150, and a central computing system 102 in data communication with communication device 106 via a WAN 104. Weapon system 100 may include additional weapons similar to weapon 120 (not shown) as well as additional communication devices similar to communication device 106 (shown). Central computing system 102 can gather data from users and weapons within the simulated environment to provide both real-time tracking and post-hoc analysis. This data can include, where users are, where and when weapons are used, who shot whom with what weapons, etc.

In some embodiments, weapon 120 may be modified to include an internal laser 108 situated within the barrel, action, chamber, and/or cylinder of the weapon. In some embodiments, internal laser 108 is placed within weapon 120 by being inserted into barrel 122 or into the chamber of weapon 120. In some embodiments, internal laser 108 is responsive to the trigger of weapon 120 such that internal laser 108 may be configured to emit/transmit a first light signal 112 in response to the trigger of weapon 120 being pressed by a user. First light signal 112 may be a low energy light signal that is directed toward the end of barrel 122. First light signal 112 may be a non-information containing light signal, and may have a duration of a few milliseconds, such that emitting first light signal 112 consumes a minimal amount of battery power. In one implementation, internal laser 108 is a light source which may be part of a simulation subsystem designed to simulate recoil, sound, and/or other physical firing effects.

In some embodiments, weapon attachment 150 may be attached to the end of barrel 122 such that it may receive first light signal 112. Weapon attachment 150 may serve as an interface between internal laser 108 and other components of weapon system 100, such as instrumentation laser 110 and communication device 106. For example, reception of first light signal 112 by weapon attachment 150 may cause weapon attachment 150 to trigger instrumentation laser 110. In response to being triggered by weapon attachment 150, instrumentation laser 110 may emit/transmit a second light signal 114. Second light signal 114 may be a high energy light signal that is directed toward a target. Second light signal 114 may be an information containing light signal that identifies a user of weapon 120 and/or an identifier associated with weapon 120, instrumentation laser 110, or weapon attachment 150. Because instrumentation laser 110 is situated outside of weapon 120, the battery associated with instrumentation laser 110 may be easily replaced and may occupy a greater volume than the battery associated with internal laser 108. In at least one implementation, instrumentation laser 110 house its own battery.

Although instrumentation laser 110 is shown in FIG. 1 as being attached to barrel 122, in other embodiments it may be mountable to weapon 120 at a variety of locations (e.g., via Picatinny rail) and/or incorporated into an optical scope. One of the primary functions of instrumentation laser 110 may be to simulate the firing of weapon 120. Accordingly, the location of instrumentation laser 110 may be such that second light signal 114 is emitted/transmitted parallel with respect to barrel 122. Furthermore, second light signal 114 can be bore sighted to weapon 120 so that the trajectory of second light signal 114 is substantially aligned with the trajectory a bullet would take during a live firing of weapon 120. In some embodiments, one or more light receivers may be disposed on a simulated target (e.g., a soldier in a simulation). These light receivers, which are communicatively coupled with central computing system 102, can receive second light signal 114, demodulate the information encoded thereon, and provide that information to central computing system 102. This allows the simulation to determine that a target has been hit (and potentially where it has been hit, if the target has several light sensors disposed thereon), and by which weapon.

In some embodiments, reception of first light signal 112 by weapon attachment 150 may cause weapon attachment 150 to communicate information with communication device 106. In some embodiments, communication device 106 may be carried by a user on his/her clothing or gear, such as attached to a belt or backpack of the user. Communication device 106 may receive various information from weapon attachment 150 such as, but not limited to, a three-dimensional location of weapon 120, an orientation of weapon 120, a time stamp indicating the time at which the user pressed the trigger of weapon 120, an identifier associated with weapon 120, a confirmation that instrumentation laser 110 emitted/transmitted second light signal 114, a copy of a message transmitted within second light signal 114, and the like. In some embodiments, communication device 106 may communicate the information it receives from weapon attachment 150 with central computing system 102 via a WAN 104. In some embodiments, WAN 104 is a long-term evolution (LTE) network and comprises a plurality of cellular radio towers.

In some embodiments, communication device 106 is further configured to gather information from one or more light receivers of a light receiver system positioned on a user. The light receiver system may determine which of the one or more light receivers has been shot, by which weapon, and by which other user. Communication device 106 may then communicate this information to central computing system 102. In some instances, central computing system 102 may compare and correlate information from different communication devices to detect discrepancies. For example, for each user that is shot, central computing system 102 may check to see whether the corresponding user reported firing a shot at or around the same time stamp as the user that was shot.

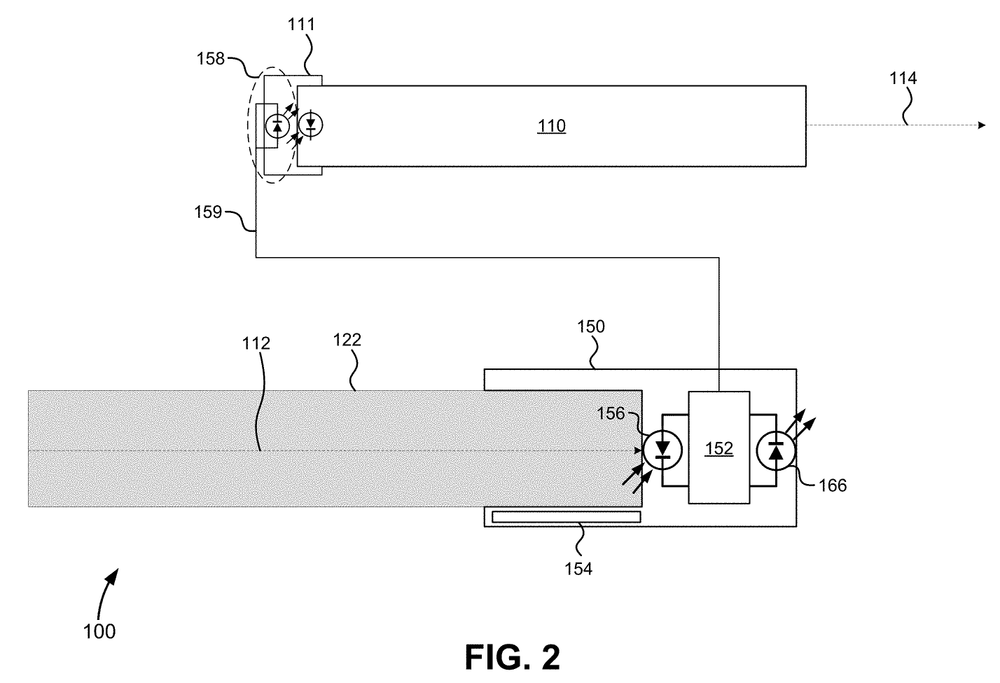

FIG. 2 shows an example of various components within weapon system 100, according to some embodiments of the present disclosure. In some embodiments, weapon attachment 150 may receive first light signal 112 via a light receiving device 156. Although light receiving device 156 is shown in FIG. 2 as a photodiode, light receiving device 156 may be any number of devices that convert an optical signal into an electrical signal. In some embodiments, weapon attachment 150 includes a processing unit 152 for receiving first light signal 112 (i.e., an electrical signal associated with first light signal 112). Processing unit 152 can include one or more processing devices such as central processing units (CPUs), digital signal processing (DPS) units, microprocessors, application-specific integrated circuits (ASICs) or other special-purpose processors, graphics processing units (GPUs), programmable processing units (e.g., programmable logic arrays (PLAs), field-programmable gate arrays (FPGAs), and/or the like.

In some embodiments, weapon attachment 150 includes a light emitting device 166 for emitting/transmitting a light signal. Although light emitting device 166 is shown in FIG. 2 as a light-emitting diode (LED), light emitting device 166 may be any number of devices that convert an electrical signal into an optical signal. In some embodiments, processing unit 152 causes the light signal emitted/transmitted by light emitting device 166 to mimic or approximate first light signal 112. In other embodiments, processing unit 152 causes the light signal emitted/transmitted by light emitting device 166 to have higher energy than first light signal 112.

In some embodiments, weapon attachment 150 transmits instructions to instrumentation laser 110 via a first interface 158. Although first interface 158 is shown in FIG. 2 as an LED (e.g., using infrared frequencies) which transmits to a photodiode within instrumentation laser 110, first interface 158 may employ any number of wired or wireless communication techniques. In some embodiments, weapon attachment 150 employs a connection 159 (wired or wireless) that conveys information through a cap 111 attached to one end of instrumentation laser 110. Cap 111 may be used to protect the physical connection between first interface 158 and instrumentation laser 110, preserve an orientation of instrumentation laser 110, and/or shield an optical connection from external light. In some embodiments, connection 159 comprises a wire that is connected to cap 111 or is directly connected to instrumentation laser 110, allowing weapon attachment 150 to immediately transmit instructions to instrumentation laser 110 upon receiving first light signal 112. In some embodiments, connection 159 and first interface 158 comprise a universal serial bus (USB) connection such that the battery of instrumentation laser 110 may supply power to weapon attachment 150.

In some embodiments, weapon attachment 150 includes an orientation module 154 positioned at least partially parallel to barrel 122 such that orientation module 154 may detect an orientation of weapon 120. In some embodiments, orientation module 154 includes various orientation sensors, such as one or more gyroscopes, one or more accelerometers, and one or more global positioning system (GPS) locators. In one implementation, the orientation sensors are configured to sample data periodically at a first rate (e.g., every 100 milliseconds) when weapon 120 is not firing and to sample data periodically at a second rate (e.g., every 25 milliseconds) when weapon 120 is firing. Data sampled while weapon 120 is not firing may have higher accuracy than data sampled while weapon 120 is firing (e.g., due to vibrations of weapon 120), and may be extrapolated to improve the accuracy of the data sampled while weapon 120 is firing. The second sampling rate may be set higher than the first sampling rate to compensate for the lower accuracy of the sampled data and to provide high temporal resolution for automatic firing weapons. In some embodiments, the data sampled by orientation module 154 may be in raw form, such that actual orientation estimates are generated by processing unit 152 after the sampled data is received by orientation module 154. In other embodiments, orientation module 154 may provide orientation estimates to processing unit 152. In some embodiments, the output of the orientation module 154 (or corresponding output of processing unit 152 to the communication device 106) may include orientation information (e.g., pitch, yaw, roll) that may be combined with GPS location (or other translation information) to obtain the full six degrees of freedom of weapon 120 when fired. GPS information may be generated within orientation module 154, elsewhere in weapon attachment 150, or elsewhere on weapon 120.

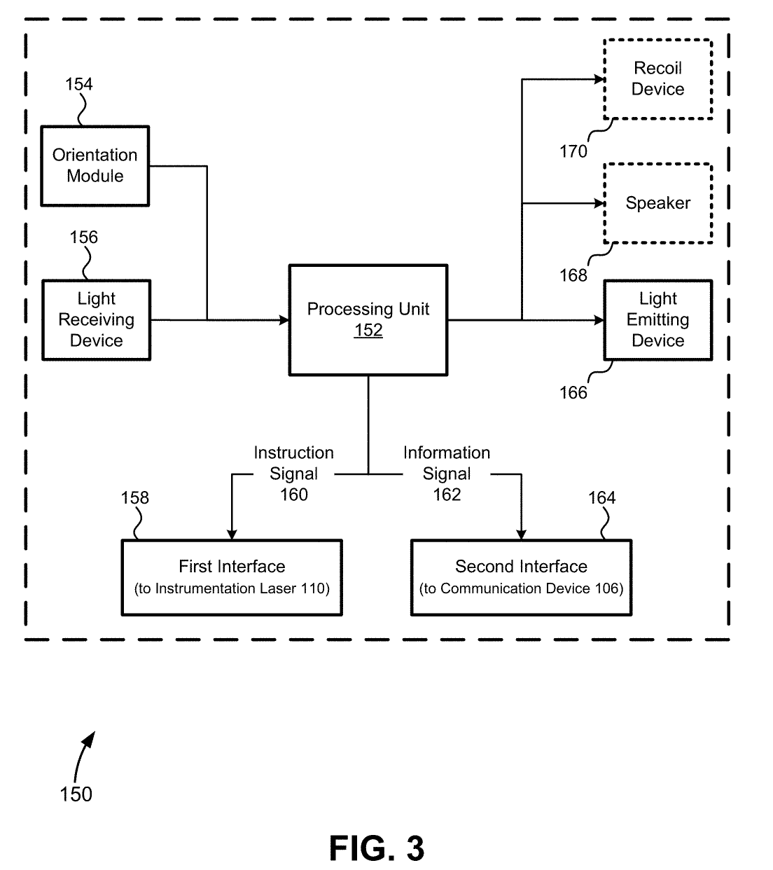

FIG. 3 shows an example of a block diagram of weapon attachment 150, according to some embodiments of the present disclosure. Weapon attachment 150 may include various output devices for simulating live firing conditions of a weapon. For example, in some embodiments, weapon attachment 150 includes a recoil device 170 that causes weapon 120 to experience recoil similar to that experienced when firing a live round. In some embodiments, upon receiving first light signal 112 via light receiving device 156, processing unit 152 may cause recoil device 170 to immediately activate. Recoil device 170 may be optional in embodiments in which recoil is provided by other devices.

As another example, weapon attachment 150 may include a speaker 168 for outputting an audio signal that imitates a gunshot. In some embodiments, upon receiving first light signal 112 via light receiving device 156, processing unit 152 may cause speaker 168 to output the gunshot audio signal. The gunshot audio signal may be altered based on the spacing between consecutive gunshots. For example, consecutive gunshots with a 100 millisecond spacing may have different audio cues than consecutive gunshots with a 500 millisecond spacing. Speaker 168 may be optional in embodiments in which recoil is provided by other devices. In some embodiments, weapon attachment 150 may include light emitting device 166 for emitting/transmitting a low energy light signal for imitating a muzzle flash of weapon 120. In some embodiments, upon receiving first light signal 112 via light receiving device 156, processing unit 152 may cause light emitting device 166 to output the light signal. The outputted light signal may be altered based on the spacing between consecutive outputted light signals. For example, consecutive light signals with a smaller spacing may have smaller muzzle flashes.

In some embodiments, upon (or in response to) receiving first light signal 112 via light receiving device 156, processing unit 152 may transmit an instruction signal 160 to instrumentation laser 110 via first interface 158. First interface 158 may be a wired or wireless interface, as described in reference to FIG. 2. In some embodiments, instruction signal 160 may indicate a time duration for emitting second light signal 114 as well as information that may be encoded within second light signal 114, such as a GPS location of weapon 120, an orientation of weapon 120, a time stamp indicating the time at which the user pressed the trigger of weapon 120, an identifier associated with weapon 120, and the like. The time duration for emitting second light signal 114 may be on the order of milliseconds or microseconds, and may be dependent on the firing rate of weapon 120 such that distinct pulses of second light signal 114 may be detected by a light receiver.

In some embodiments, processing unit 152 may transmit an information signal 162 to communication device 106 via a second interface 164. Second interface 164 may be a wired or wireless interface. In one embodiment, second interface 164 enables processing unit 152 to transmit information signal 162 using a Bluetooth® connection. In other words, weapon attachment 150 may include a Bluetooth® transmitter (or transceiver) and communication device 106 may include a Bluetooth® receiver (or transceiver). In some embodiments, second interface 164 may also include any one of various types of wireless technologies, such as Institute of Electrical and Electronics Engineers (IEEE) 802.11, IEEE 802.15, IEEE 802.16, Near-Field Communications (NFC), and the like. In some embodiments, information signal 162 may include various information such as, but not limited to, a GPS location of weapon 120, an orientation of weapon 120, a time stamp indicating the time at which the user pressed the trigger of weapon 120, an identifier associated with weapon 120, a confirmation that instrumentation laser 110 emitted/transmitted second light signal 114, a confirmation that weapon attachment 150 received first light signal 112, and the like.

In some embodiments, the information contained in information signal 162 may be communicated in real-time with central computing system 102 by communication device 106 via WAN 104. Central computing system 102 may then analyze and compare the received information to that received from other communication devices. In some instances, such as during an infantry training exercise, central computing system 102 may provide real-time feedback to the various communication devices. The feedback may include, but is not limited to, the accuracy of a particular weapon in hitting a particular target, the number of rounds used and/or the number of rounds remaining for a particular weapon, the total number of enemy or friendly infantry involved in a training exercise, the number of enemy or friendly infantry remaining in a training exercise, the distance between a particular weapon and a particular target, the number of completed objectives, the number of remaining objectives, and the like. In some embodiments, this feedback is communicated to a user of weapon 120 through either a digital display located on firing attachment 150 or an audio cue outputted using speaker 168. For example, the feedback may be transmitted to weapon attachment 150 using second interface 164.

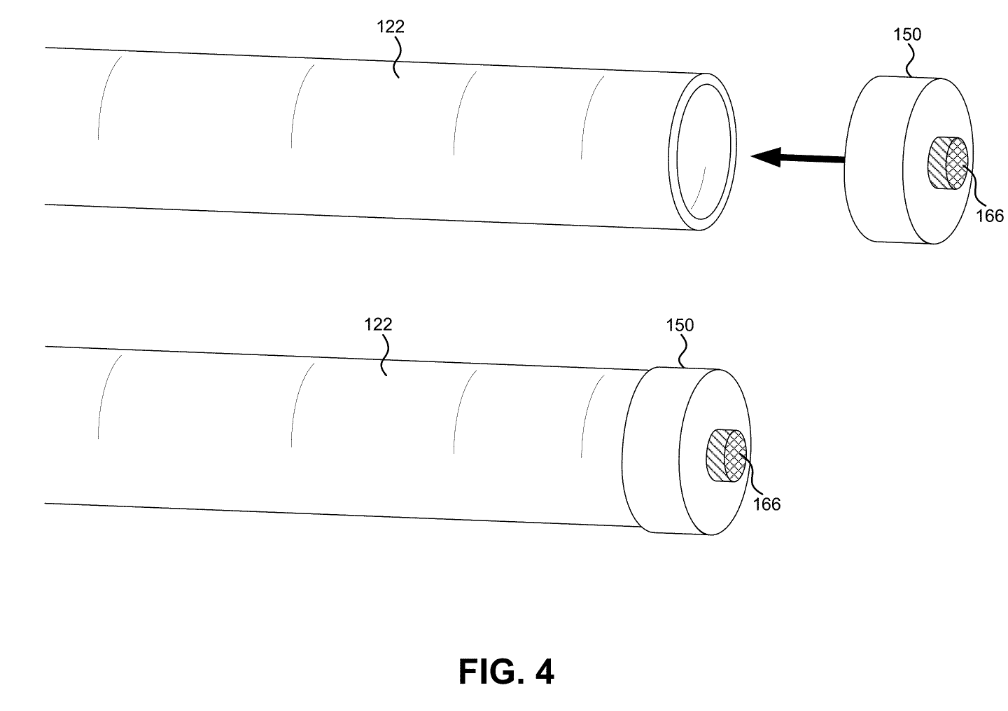

FIG. 4 shows an example of weapon attachment 150 attaching to the end of barrel 122 of weapon 120, according to some embodiments of the present disclosure. In the specific embodiment shown in FIG. 4, weapon attachment 150 has a cap-like shape enabling it to be fitted over the opening of barrel 122, completely covering the opening of barrel 122. Light emitting device 166 is positioned at a central location of the outward surface of weapon attachment 150, and light receiving device 156 (not shown) is positioned at a central location of the inward surface (opposite of the outward surface) of weapon attachment 150 such that it may receive first light signal 112 transmitted within barrel 122. The specific embodiment shown in FIG. 4 is consistent with the embodiments of weapon attachment 150 shown in FIGS. 1 and 2.

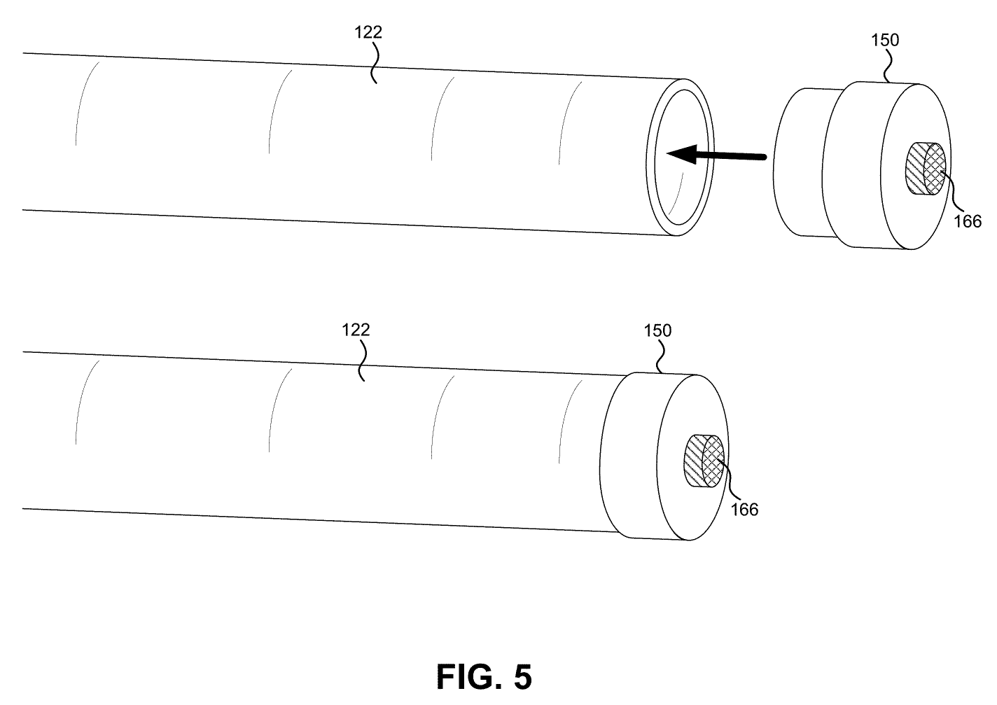

FIG. 5 shows an example of weapon attachment 150 attaching to the end of barrel 122 of weapon 120, according to some embodiments of the present disclosure. In the specific embodiment shown in FIG. 5, weapon attachment 150 has a plug-like shape enabling it to be inserted into the opening of barrel 122, completely covering the opening of barrel 122. Light emitting device 166 is positioned at a central location of the outward surface of weapon attachment 150, and light receiving device 156 (not shown) is positioned at a central location of the inward surface (opposite of the outward surface) of weapon attachment 150 such that it may receive first light signal 112 transmitted within barrel 122.

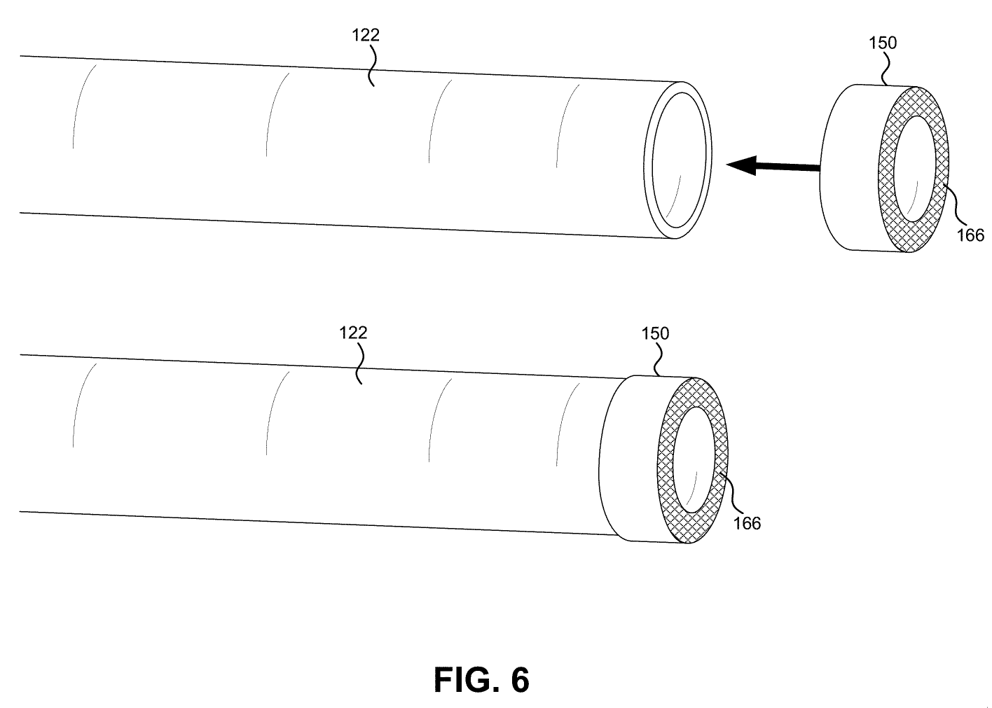

FIG. 6 shows an example of weapon attachment 150 attaching to the end of barrel 122 of weapon 120, according to some embodiments of the present disclosure. In the specific embodiment shown in FIG. 6, weapon attachment 150 has a hollowed cap-like shape enabling it to be fitted over the opening of barrel 122, partially covering the opening of barrel 122 and allowing a portion of first light signal 112 to exit barrel 122. Light emitting device 166 is positioned along the outward surface of weapon attachment 150, and light receiving device 156 (not shown) is positioned along an inside surface of weapon attachment 150 such that it may receive first light signal 112 transmitted within barrel 122.

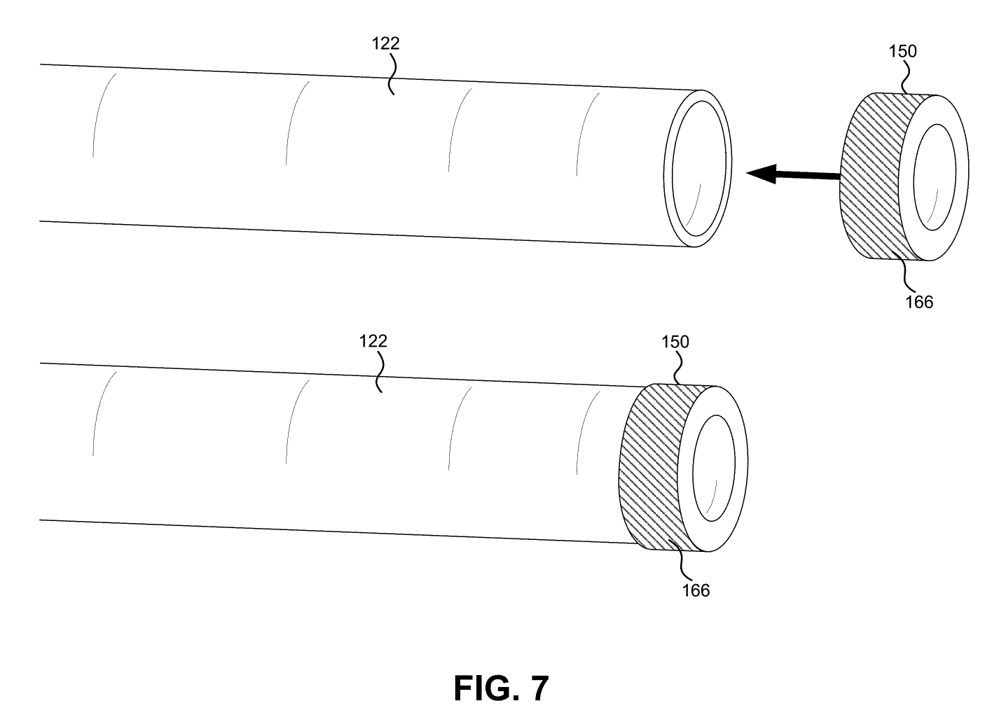

FIG. 7 shows an example of weapon attachment 150 attaching to the end of barrel 122 of weapon 120, according to some embodiments of the present disclosure. In the specific embodiment shown in FIG. 6, weapon attachment 150 has a hollowed cap-like shape enabling it to be fitted over the opening of barrel 122, partially covering the opening of barrel 122 and allowing a portion of first light signal 112 to exit barrel 122. Light emitting device 166 is positioned along the outside surface (in the radial direction) of weapon attachment 150, and light receiving device 156 (not shown) is positioned along an inside surface (in the radial direction) of weapon attachment 150 such that it may receive first light signal 112 transmitted within barrel 122.

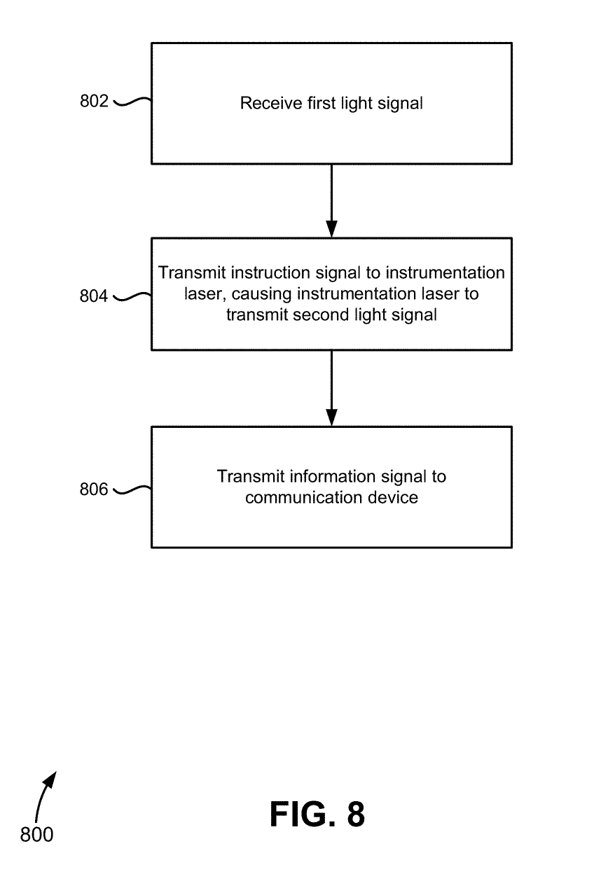

FIG. 8 shows an example of a flow diagram of a method 800, according to some embodiments of the present disclosure. Method 800 can be implemented, for example, by a weapon attachment containing one or more processors, such as weapon attachment 150 and processing unit 152. Other embodiments may vary in functionality from the functionality shown. Variations may include performing additional functions, substituting functions, performing functions in a different order or simultaneously, and the like.

At block 802, first light signal 112 is received. In some embodiments, first light signal 112 is transmitted within barrel 122 by internal laser 108. In some embodiments, first light signal 112 is caused to be transmitted upon, or in response to, a user of weapon 120 pressing the trigger of weapon 120. In some embodiments, first light signal 112 is received by light receiving device 156 and subsequently/simultaneously by processing unit 152.

At block 804, instruction signal 160 is transmitted by processing unit 152 to instrumentation laser 108 via first interface 158. In some embodiments, instruction signal 160 causes instrumentation laser 108 to transmit second light signal 114. In some embodiments, instruction signal 160 is transmitted by processing unit 152 upon, or in response to, performance of block 802. In some embodiments, instruction signal 160 indicates a time duration for emitting second light signal 114 and an ID number associated with weapon 120.

At block 806, information signal 162 is transmitted by processing unit 152 to communication device 106 via second interface 164. In some embodiments, communication device 106 is configured to communicate with central computing system 102 via WAN 104. In some embodiments, information signal 162 is transmitted by processing unit 152 upon, or in response to, performance of block 802.

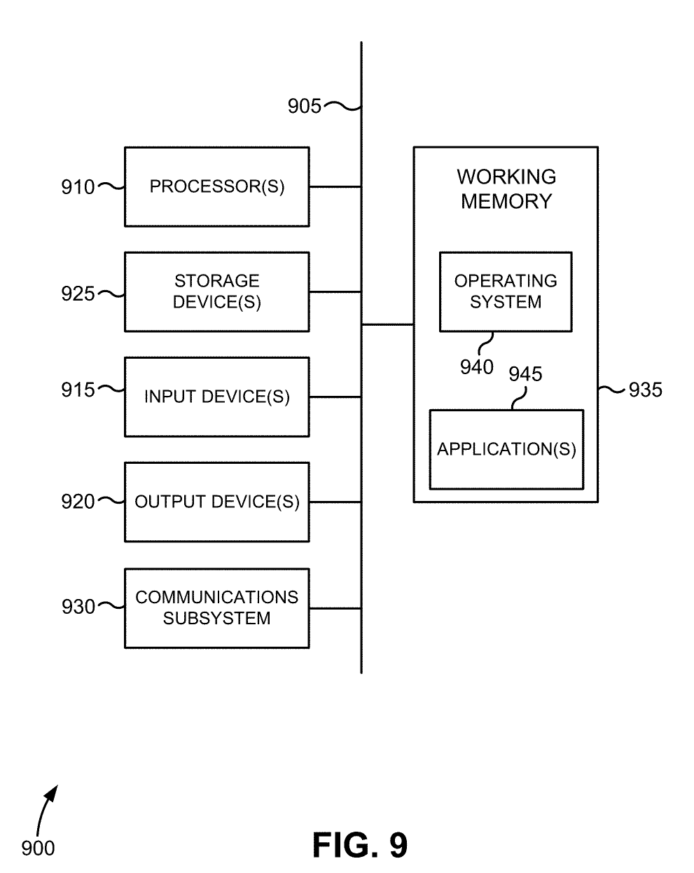

FIG. 9 shows an example of a simplified computer system 900, according to some embodiments of the present disclosure. Aspects of computer system 900 may be incorporated into weapon attachment 150. A computer system 900 as illustrated in FIG. 9 may be incorporated into devices such as a portable electronic device, mobile phone, or other device as described herein. FIG. 9 provides a schematic illustration of one embodiment of a computer system 900 that can perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905, or may otherwise be in communication, as appropriate. The hardware elements may include one or more processors 910, including without limitation one or more general-purpose processors and/or one or more special-purpose processors such as digital signal processing chips, graphics acceleration processors, and/or the like; one or more input devices 915, which can include without limitation a mouse, a keyboard, a camera, and/or the like; and one or more output devices 920, which can include without limitation a display device, a printer, and/or the like.

The computer system 900 may further include and/or be in communication with one or more non-transitory storage devices 925, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device, and/or a chipset such as a Bluetooth® device, an 802.11 device, a Wi-Fi device, a WiMAX™ device, cellular communication facilities, etc., and/or the like. The communications subsystem 930 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 930. In other embodiments, a portable electronic device, e.g. the first electronic device, may be incorporated into the computer system 900, e.g., an electronic device as an input device 915. In some embodiments, the computer system 900 will further comprise a working memory 935, which can include a RAM or ROM device, as described above.

The computer system 900 also can include software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 9, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 925 described above. In some cases, the storage medium might be incorporated within a computer system, such as computer system 900. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 900 and/or might take the form of source and/or installable code, which, upon compilation and/or installation on the computer system 900 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 900 to perform methods in accordance with various embodiments of the technology. According to a set of embodiments, some or all of the procedures of such methods are performed by the computer system 900 in response to processor 910 executing one or more sequences of one or more instructions, which might be incorporated into the operating system 940 and/or other code, such as an application program 945, contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processor(s) 910 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 925. Volatile media include, without limitation, dynamic memory, such as the working memory 935.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 930 and/or components thereof generally will receive signals, and the bus 905 then might carry the signals and/or the data, instructions, etc. carried by the signals to the working memory 935, from which the processor(s) 910 retrieves and executes the instructions. The instructions received by the working memory 935 may optionally be stored on a non-transitory storage device 925 either before or after execution by the processor(s) 910.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A weapon attachment for attaching to a barrel of a weapon, the weapon attachment comprising:
a light receiving device configured to receive a first light signal transmitted within the barrel;
a first interface for communicating with a weapon-mountable instrumentation laser, wherein the instrumentation laser is configured to transmit a second light signal;
a processing unit coupled with the light receiving device, the processing unit configured to perform operations comprising:
receiving, via the light receiving device, the first light signal; and
in response to receiving the first light signal, transmitting an instruction signal to the instrumentation laser via the first interface, the instruction signal causing the instrumentation laser to transmit the second light signal.

2. The weapon attachment of claim 1, further comprising:
a second interface for communicating with a communication device via wireless radio frequency (RF) signals.

3. The weapon attachment of claim 2, wherein the operations further comprise:
in response to receiving the first light signal, transmitting an information signal to the communication device via the second interface, the information signal indicating that the first light signal was received by the weapon attachment.

4. The weapon attachment of claim 2, wherein the second interface enables the processing unit to transmit the information signal to the communication device using a Bluetooth connection.

5. The weapon attachment of claim 1, wherein the first light signal is transmitted by an internal laser.

6. The weapon attachment of claim 2, further comprising:
an orientation module configured to detect an indication of an orientation of the weapon and to send the indication of the orientation of the weapon to the processing unit.

7. The weapon attachment of claim 1, wherein the first interface enables the processing unit to transmit the instruction signal to the instrumentation laser using an infrared wireless connection.

8. A method comprising:
receiving, by a processing unit via a light receiving device, a first light signal transmitted within a barrel of a weapon, wherein a weapon attachment for attaching to the barrel of the weapon includes the processing unit and the light receiving device; and
in response to receiving the first light signal, transmitting, by the processing unit, an instruction signal to a weapon-mountable instrumentation laser via a first interface, the instruction signal causing the instrumentation laser to transmit a second light signal.

9. The method of claim 8, wherein the weapon attachment includes a second interface for communicating with a communication device via wireless radio frequency (RF) signals.

10. The method of claim 9, further comprising:
in response to receiving the first light signal, transmitting, by the processing unit, an information signal to the communication device via the second interface, the information signal indicating that the first light signal was received by the weapon attachment.

11. The method of claim 9, wherein the second interface enables the processing unit to transmit the information signal to the communication device using a Bluetooth connection.

12. The method of claim 8, wherein the first light signal is transmitted by an internal laser.

13. The method of claim 9, wherein the weapon attachment includes an orientation module configured to detect an indication of an orientation of the weapon and to send the indication of the orientation of the weapon to the processing unit.

14. The method of claim 8, wherein the first interface enables the processing unit to transmit the instruction signal to the instrumentation laser using an infrared wireless connection.

15. A non-transitory computer readable medium comprising instructions that, when executed by a processing unit, cause the processing unit to perform operations comprising:
receiving, by the processing unit via a light receiving device, a first light signal transmitted within a barrel of a weapon, wherein a weapon attachment for attaching to the barrel of the weapon includes the processing unit and the light receiving device; and
in response to receiving the first light signal, transmitting, by the processing unit, an instruction signal to a weapon-mountable instrumentation laser via a first interface, the instruction signal causing the instrumentation laser to transmit a second light signal.

16. The non-transitory computer readable medium of claim 15, wherein the weapon attachment includes a second interface for communicating with a communication device via wireless radio frequency (RF) signals.

17. The non-transitory computer readable medium of claim 16, wherein the operations further comprise:
in response to receiving the first light signal, transmitting, by the processing unit, an information signal to the communication device via the second interface, the information signal indicating that the first light signal was received by the weapon attachment.

18. The non-transitory computer readable medium of claim 16, wherein the second interface enables the processing unit to transmit the information signal to the communication device using a Bluetooth connection.

19. The non-transitory computer readable medium of claim 15, wherein the first light signal is transmitted by an internal laser.

20. The non-transitory computer readable medium of claim 16, wherein the weapon attachment includes an orientation module configured to detect an indication of an orientation of the weapon and to send the indication of the orientation of the weapon to the processing unit.
